(19) United States
(12) Patent Application Publication
(10) Pub. No.: US 2011/0238626 A1
(43) Pub. Date: Sep. 29, 2011

(54) AUTOMATIC USER DEVICE BACKUP

(75) Inventors: Jack Jianxiu HAO, Lexington, MA (US); Haiyan ZHOU, Waltham, MA (US); Jian HUANG, Sudbury, MA (US); Baoqing YE, Acton, MA (US)

(73) Assignee: VERIZON PATENT AND LICENSING, INC., Basking Ridge, NJ (US)

(21) Appl. No.: 12/730,765

(22) Filed: Mar. 24, 2010

(51) Int. Cl. G06F 17/30; G06F 15/16

(52) U.S. Cl. 707/644; 709/219; 707/E17.005; 707/E17.032; 707/E17.044

(57) ABSTRACT

A user device connects to a global server via a public network and to a local server via a private network. The user device is configured to store information and preferences, where the preferences include information regarding a type of backup permitted by a user of the user device; determine that the preferences permit a local backup to the local server; determine whether a connection, to the local server, can be established, via the private network, based on the determination that the preferences permit the local backup; send at least some of the information to the local server and via the connection through the private network, when the connection to the local server can be established; and send, the at least some of the information to the local server, via the global server and the public network, when the connection to the local server cannot be established.

### BACKGROUND

Today's user devices are capable of performing an ever-increasing variety of functions and tasks that continue to improve the user's experience. User devices can run a variety of applications, can connect to a variety of wired and wireless networks, and can handle an array of data and communications, such voice, video, text and data. As functionality and performance improve, users are relying more and more on user devices for everyday tasks, such as personal organization (e.g., address book, calendar, schedule, etc.), mobile communications, word processing, Internet surfing, electronic messaging, gaming, etc. As a result, users are storing increasing amounts of user information, such as personal data, images, documents, and other information in user devices. Unfortunately, users run the risk of losing large amounts of user information if the user device, in which the user information is stored, is not regularly backed up.

### BRIEF DESCRIPTION OF THE DRAWINGS

FIG. 1 is a diagram that illustrates an overview of an automatic user device backup implementation described herein;

FIG. 2 is a diagram of an exemplary network in which systems and/or methods described herein may be implemented;

FIG. 3 is a diagram of exemplary components of one or more of the devices of FIG. 2;

FIG. 4 is a diagram of an exemplary user device of FIG. 2;

FIG. 5 is a diagram of exemplary components of the user device of FIG. 4;

FIG. 6 is a flowchart of an exemplary process for specifying backup preferences within an exemplary portion of the network of FIG. 2;

FIG. 7 is a diagram of an exemplary backup preferences user interface that is capable of being presented on the user device of FIG. 2;

FIG. 8 is a flowchart of an exemplary process for registering a local server with a global server within the network of FIG. 2;

FIG. 9 is a flowchart of an exemplary process for registering a user device with a global server within the network of FIG. 2;

FIG. 10 is a flowchart of an exemplary process for automatically backing up a user device within the network of FIG. 2; and

FIG. 11 is a flowchart of another exemplary process for automatically backing up a user device within the network of FIG. 2.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

An implementation described herein may include systems and/or methods that provide for automatic user device backup using a technique that can automatically perform a backup operation on a user device that enables information, stored on the user device, to be backed up by storing a copy of the information on another device. Additionally, or alternatively, the automatic backup operation may be performed in a manner that is transparent to a user of the user device and which protects information, stored on the user device, from being lost in the event that the user device is misplaced and/or otherwise becomes inoperable. The automatic backup operation may be performed using a local network (e.g., a home Wi-Fi network or a home wired network) that may reduce bandwidth demand on access/metro networks. If a local network is not available, the automatic backup operation may be performed on a service provider network or other networks that are available.

As described herein, a backup application, hosted by a user device, may include software that performs a set up operation that permits a user of the user device to specify backup preferences. The backup preferences may include the timing and/or frequency by which the user device is to be backed up, the method of the backup operation (e.g., via a home network, the Internet, etc.), and/or information security preferences (e.g., a local backup to a home server, remote backup to a global server, etc.). The backup application may enable the user device to perform a registration operation. For example, the backup application may permit a user device to be registered with a global server that may control or facilitate the automatic backup operations.

As further described herein, a local server may perform a registration operation. For example, a local server, associated with the user device, may be registered with the global server that may enable the local server to receive information uploaded from the user device. The uploaded information may be obtained directly from the user device via a local network or may be retrieved from temporary storage, associated with the global server, via a network, such as the Internet and/or a carrier network.

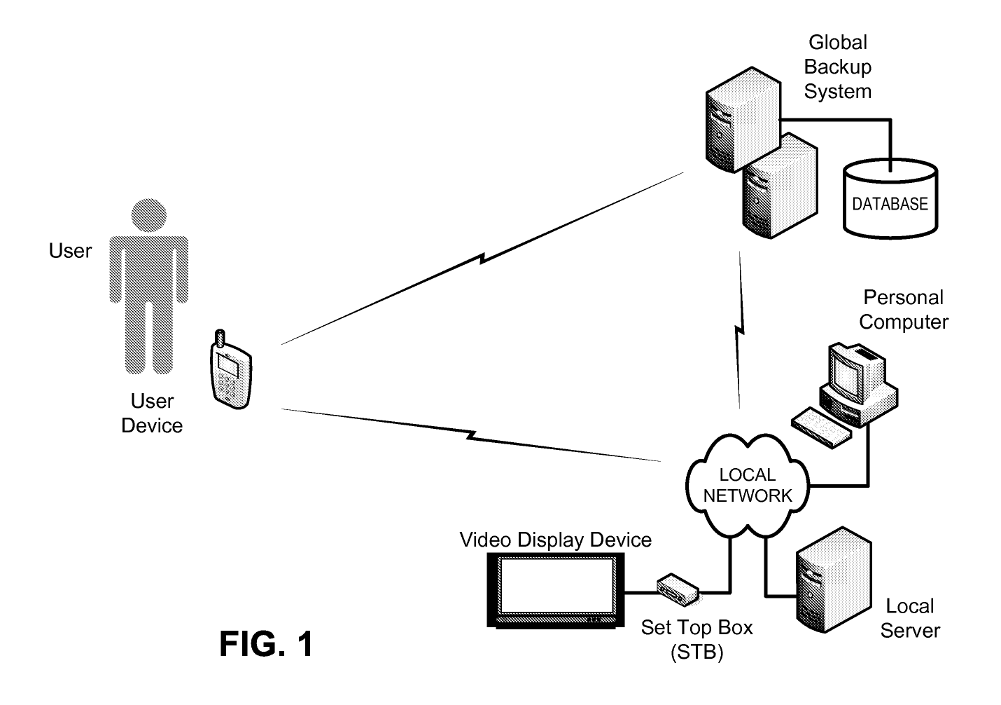

As yet further described here, a user device may perform a local backup operation, a remote backup operation or a combination of a local backup operation and remote backup operation. For example, a user of a user device may specify, in the backup preferences, that information may only be backed up via a local backup operation. In this example, the user device may upload information, via a local network, for storage by a local server. In another example, the user of a user device may indicate a preference for information to be backed up via a remote backup operation. In this example, the user device may upload information to a global system (as shown in FIG. 1), via a global accessible network (e.g., a service provider network, the Internet, etc.) to be stored. In yet another example, the user may indicate that information may be backed up by a remote backup operation or local backup operation. In this example, the user device may backup information depending on the type of network that is available. If a local network is available, the user device may backup the information to the local server. If, however, a local network is not available, then the user device may backup the information to the global server.

The term “information,” as used herein, may include any data that is stored on a user device and is capable of being backed up via a local backup operation and/or a remote backup operation. For example, information may include username, password, personal information, email information, metadata, documents, video, voicemail, applications, etc.

FIG. 1 is a diagram that illustrates an overview of an automatic user device backup implementation described herein. As illustrated in FIG. 1, a user device may store information and may be connected to a global backup system and/or a local network. The global backup system may include a global server, a global backup server and/or a database. The global backup system may be connected to the user device and the local network. The local network may include a personal computer, a local server, a set top box (STB) connected to a video display device, and/or another network device. The personal computer, the local server, and the STB may be interconnected by a local network that may include wired and/or wireless connections.

A set up operation may be performed. For example, a backup application, hosted by the user device, may present a backup preferences user interface for display on the user device. The backup preferences user interface may permit a user, of the user device, to set up backup preferences for the user device. More particularly, the user may specify whether a backup operation is to be automatically performed at particular intervals (e.g., weeks, days, hours, minutes, etc.); automatically performed at a trigger event, such as when new information is saved to the user device, and/or the user device is being charged; and/or manually performed, such as when the user presses a particular button on the user device. Additionally, or alternatively, the user may specify the location and/or the method that the backup operation is to be performed. For example, the user may specify that the user device is to be backed up via the local network. Additionally, or alternatively, the user may indicate that the backup operation be performed via a global network, such as via the Internet and/or via a service provider network, etc. The user may specify information security preferences for the backup operation. For example, the user may specify that the information is to be backed up, via a local backup operation, to the local server and/or a personal computer. In another example, the user may specify that the information is to be backed up, via a remote backup operation, to a global backup system.

A local server registration operation may be performed. For example, a local server, a personal computer and/or some other device connected to the local network may be registered with the global backup system that may permit information to be backed up to the local server, personal computer, etc. The local server may send a request to register to the global backup system. The request may include information associated with the local network (e.g., a local server address, a STB identifier, etc.), and/or information associated with the user (e.g., username, password, email address, personal identification number (PIN), etc.). Once registered, the local server may send periodic status notifications to indicate, to the global backup system, that the local server is online and/or is available.

A user device registration operation may be performed. For example, a user device may be registered with the global backup system that may permit information to be backed up to the local server and/or the global backup system. The user device may send a request to register to the global backup system. The request may include information associated with the local network (e.g., the STB identifier, etc.), and/or information associated with the user (e.g., username, password, email address, PIN, etc.). Once registered, the user device may receive an address associated with the local server and may store the address for use when a local backup operation is performed.

A local backup operation may be performed. For example, the user device may receive new information and the backup application may initiate a backup operation. The backup application may retrieve backup preferences from the memory of the user device to determine whether the user desires that information be backed up via a local backup operation or a remote backup operation. If the user preferences indicate that a local backup operation is to be performed, the user device may send a notification to the global backup system to determine whether the local server is online and/or is available. When it is determined that the local server is online (e.g., available) and/or that the local network is available, the user device may communicate with the local server to determine which information to upload to the local server. For example, the user device may send a list of files, associated with information stored by the user device, to the local server. The local server may receive the list of files and may determine which files on the list are not backed up in a memory associated with the local server. The local server may send an upload list to the user device that includes the files to be uploaded to the user device. The user device may receive the upload list and may retrieve, from memory, information associated with the upload list. The user device may send the retrieved information to the local server.

In another example, the user device may use timestamp information, associated with information stored by the user device, to determine which information to upload. In this example, the user device may upload information, stored by the user device during a time period that is after a particular time that corresponds to when the previous backup operation was performed. In yet another example, the user device may index and/or store pending information to a memory and may upload the pending information based on the index during another backup operation (e.g., at a future point in time).

In still another example, if the local network is not available and/or if the local server is not online (e.g., is offline or otherwise unavailable), then the user device may upload information to the global backup system. The global backup system may receive the information and may temporarily store the information in a memory associated with the global backup system. The local server may periodically communicate with the global backup system to check whether there is information to be downloaded to the local server and may download the information for storage in a memory associated with the local server.

A remote backup operation may be performed. For example, the backup application may automatically initiate a backup operation based on the backup preferences that specify that a backup operation is to be performed at periodic time intervals (e.g., every twelve hours, 2 hours, 30 minutes, etc.). The backup application may retrieve the backup preferences from the memory of the user device and may determine that the user has specified that a remote backup operation is to be performed. In a manner similar to that described above, the user device may upload information to the global backup system (e.g., based on timestamp information, the indexed information, or the upload list). The global backup system may receive the information and may store the information in a memory associated with the global backup system.

The automatic backup operation may enable a user to protect information stored on the user device, which may be recovered if the user device is lost, stolen or otherwise rendered inoperable. The automatic backup operation may be performed in a manner that is transparent to the user and may be performed in accordance with backup preferences specified by the user. The backup operation may permit information to be stored locally on a local server and/or remotely on a global server and/or global backup server. The automatic backup operation may be performed via a local network (e.g., a local Wi-Fi network), which may reduce bandwidth utilization on broadband networks. If a local network is not available, however, the automatic backup operation may be performed using a global network (e.g., a service provider network, the Internet, etc.).

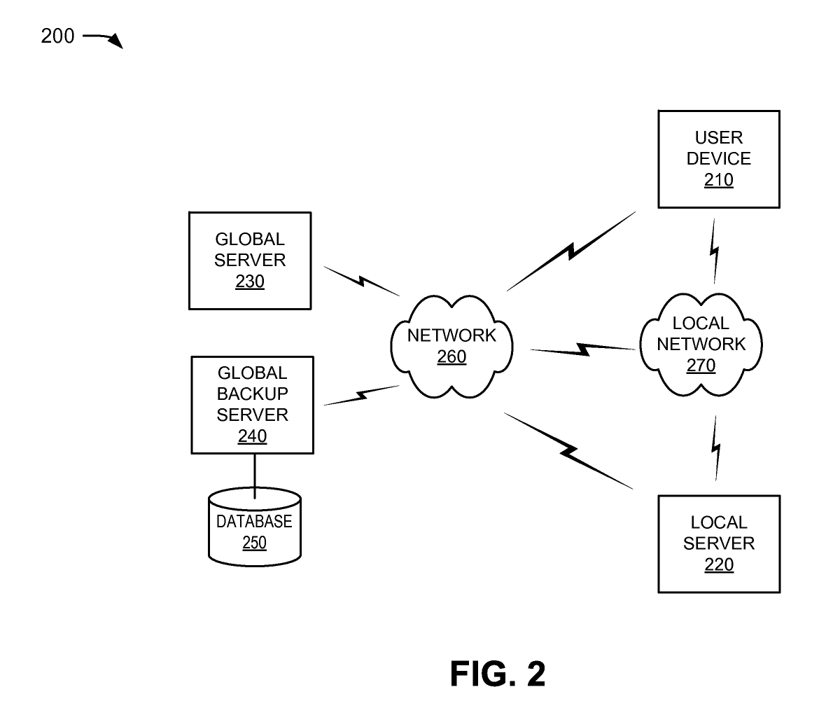

FIG. 2 is a diagram of an exemplary network 200 in which systems and/or methods described herein may be implemented. As shown in FIG. 2, network 200 may include user device 210, local server 220, global server 230, global backup server 240, database 250, network 260 and local network 270. A single user device 210, local server 220, global server 230, global backup server 240, database 250, network 260 and local network 270 are illustrated in FIG. 2 for simplicity. In practice, there may be additional, fewer, different or differently arranged user devices 210, local servers 220, global servers 230, global backup servers 240, databases 250, networks 260 and/or local networks 270.

Also, in some implementations, one or more of the devices of network 200 may perform one or more functions described as being performed by another one or more of the devices of network 200. For example, global server 230, global backup server 240 and database 250 may be integrated into a single device. In another example, local server 220 and local network 270 may be integrated into a single device. Components of network 200 may interconnect via wired connections, wireless connections, or a combination of wired and wireless connections.

User device 210 may include any computation or communication device, such as a wireless mobile device communication device that is capable of communicating with local server 220, global server 230, and/or global backup server 240. For example, user device 210 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop computer, a personal computer, a STB, a television, a camera, a personal gaming system, or another type of computation or communication device. In one implementation, user device 210 may generate and/or store information in a memory associated with user device 210. Additionally, or alternatively, user device 210 may send a registration request to global server 230. The request may include information associated with user device 210 (e.g., a user device 210 identifier, an email address, a username, a password, PIN, etc.) and/or information associated with local server 220 (e.g., an identifier associated with local server 220, such as a STB identifier). User device 210 may perform backup operations by uploading information to local server 220, global server 230, and/or global backup server 240.

User device 210 may also perform synchronization operations by communicating with local server 220, global server 230, and/or global backup server 240, to determine which files, stored on user device 210, have previously been backed up and which files have not yet been backed up. User device 210 may, based on the synchronization operation, perform a backup operation on the information that has not yet been backed up. If during the synchronization operation, user device 210 determines that local server 220, global server 230 and/or global backup server 240 contain files that are not stored on user device 210, then user device 210 may instruct local server 220, global server 230, and/or global backup server 240 to send the files to user device 210 and/or to delete the files.

The description to follow will generally refer to user device 210 as a wireless mobile communication device. The description is not limited, however, to a wireless mobile communication device and may equally apply to other types of user devices.

Local server 220 may include one or more server devices, or other types of computation or communication devices, that gather, process, search, store, and/or provide information in a manner similar to that described herein. For example, local server 220 may include a computer device (e.g., a personal computer associated with a user of user device 210), a STB, a video display device (e.g., a television and/or computer monitor) and/or a server device. Local server 220 may interface with user device 210, global server 230, and/or global backup server 240.

Local server 220 may perform registration operations and/or backup operations. For example, local server 220 may send a request to register to global server 230. The request may include information associated with user device 210 (e.g., a user device 210 identifier, an email address, a username, a password, PIN, etc.) and/or information associated with local server 220 (e.g., an identifier associated with local server 220, such as a STB identifier). Local server 220 may send periodic status notifications (e.g., every, 5 minutes, 1 minute, 30 seconds, etc.) to global server 230 to indicate whether local server 220 is online, is available, and/or is otherwise operational. Additionally, or alternatively, local server 220 may perform local backup operations by communicating with user device 210 and may receive information, from user device 210, for storage in a memory associated with local server 220. Local server 220 may perform other local backup operations by communicating with global server 230 to retrieve (e.g., by downloading) information, associated with user device 210, which may be temporarily stored (e.g., cached) in a memory associated with global server 230. Local server 220 may also perform synchronization operations by communicating with user device 210 to determine which files, stored on user device 210, have previously been backed up and which files have not yet been backed up. Local server 220 may receive files, from user device 210, that have not yet been backed up.

Global server 230 may include one or more server devices, or other types of computation or communication devices, that gather, process, search, store, and/or provide information in a manner similar to that described herein. Global server 230 may interface with user device 210, global backup server 240, and/or local server 220. Global server 230 may perform registration operations. For example, global server 230 may receive a request to register from user device 210 and/or local server 220. Global server 230 may monitor the status of user device 210, local server 220, and/or global backup server 240 and may send status notifications associated with local server 220 and/or global backup server 240, to user device 210.

Global server 230 may perform local backup operations. For example, global server 230 may receive information from user device 210 and may temporarily store the information in a memory associated with global server 230. Global server 230 may receive status notifications from local server 220 and may send notifications to local server 220 that information is available to be downloaded. Local server 220 may receive notifications from global server 230 indicating that information is available to be downloaded and may retrieve the information, in response to the notifications, from the memory associated with global server 230.

Global server 230 may perform remote backup operations. For example, global server 230 may receive information from user device 210 and may store the information in a memory associated with global server 230. Global server 230 may also perform synchronization operations by communicating with user device 210 to determine which files, stored on user device 210, have previously been backed up and which files have not yet been backed up. Based on the synchronization operation, global server 230 may receive files, from user device 210, that have not been previously backed up. In another example, global server 230 may perform the synchronization operation when a list of file identifiers, corresponding to files stored on user device 210, are received from user device 210. Global server 230 may determine that files are stored in a memory, associated with global server 230, that are not included on the list of file identifiers received from user device 210. Global server 230 may send a synchronization notification, to user device 210, indicating that particular files are stored in the memory, associated with global server 230, that are not stored on user device 210. Global server 230 may receive an instruction from user device 210 to perform a deletion operation on the particular files, to send the particular files to user device 210, or to perform some other operation on the particular files.

In another implementation, global server 230 may receive information and may temporarily store the information in a memory associated with global server 230. Global server 230 may receive status notifications from global backup server 240 and may send notifications to global backup server 240 that information is available to be downloaded. Backup server 240 may receive notifications from global server 230 indicating that information is available to be downloaded and may obtain the information, in response to the notifications, from the memory associated with global server 230.

Global backup server 240 may include one or more server devices, or other types of computation or communication devices, that gather, process, search, store, and/or provide information in a manner similar to that described herein. Global backup server 240 may interface with user device 210, global server 230, and/or local server 220.

Global backup server 240 may perform remote backup operations. For example, global backup server 240 may send periodic status notifications (e.g., every 10 minutes, 5 minutes, 1 minute, etc.) to global server 230 to indicate whether global backup server 240 is online, is available, and/or is otherwise operational. Global backup server 240 may perform remote backup operations by communicating with global server 230 to retrieve (e.g., by downloading) information, associated with user device 210, which may be temporarily stored (e.g., cached) in a memory associated with global server 230. In another implementation, global backup server 240 may perform remote backup operations by communicating directly with user device 210 and may receive information, from user device 210, for storage in a memory associated with global backup server 240 (e.g., database 250). Global backup server 240 may also perform synchronization operations by communicating with user device 210 to determine which files, stored on user device 210, have previously been backed up and which files have not yet been backed up. Based on the synchronization operation, global backup server 240 may receive files, from user device 210, that have not been previously backed up.

Database 250 may include a device to write, read and/or store information. Database 250 may interface with global backup server 240 and may store information associated with remote backup operations. For example, database 250 may receive information, associated with user device 210, from global backup server 240 and may store the information.

Network 260 may include a public network, such as a wide area network (WAN), a metropolitan area network (MAN), a telephone network (e.g., the Public Switched Telephone Network (PSTN), or a cellular network, such as the Public Land Mobile Network (PLMN), and/or a 2G, a 3G, and/or a 4G network), an ad hoc network, an intranet, the Internet, a fiber optic-based network (e.g., a fiber optic service (FiOS) network), or a combination of networks. Additionally, or alternatively, network 260 may include a broadband network, a service provider network and/or a carrier network.

Local network 270 may include a private network, such as a local area network (LAN), an ad hoc network and/or an intranet. Local network 270 may include a wired LAN and/or a wireless LAN (e.g., a Wi-Fi network). Local network 270 may not generally be accessible to the public (e.g., a private residential/home network, an office network, and/or a network, associated with some other entity, that is not generally accessible to the public).

Although not shown in FIG. 2, network 200 may include a variety of other devices, such as an authentication server, a self-provisioning server, etc. Each of these devices may perform certain functions described briefly below. Any of these functions may be performed by local server 220, global server 230 and/or global backup server 240. Thus, one or more of these devices may be integrated into local server 220, global server 230, and/or global backup server 240.

The authentication server may include one or more server devices, or other types of computation or communication devices, that authenticates user device 210. For example, the authentication server may receive a request to authenticate user device 210 based on information associated with local server 220 (e.g., an identifier associated with local server 220), information associated with a user of user device 210 (e.g., username, password, email address, PIN, etc.), and/or information associated with user device 210 (e.g., an identifier associated with user device 210).

The self-provisioning server may include one or more server devices, or other types of computation or communication devices that enables the registration of user device 210. The self-provisioning server may receive registration information from user device 210 and/or local server 220. The self-provisioning server may facilitate sending address information, associated with local server 220 and/or global backup server 240, to user device 210 and/or may forward backup preferences, associated with a user of user device 210, to global server 230.

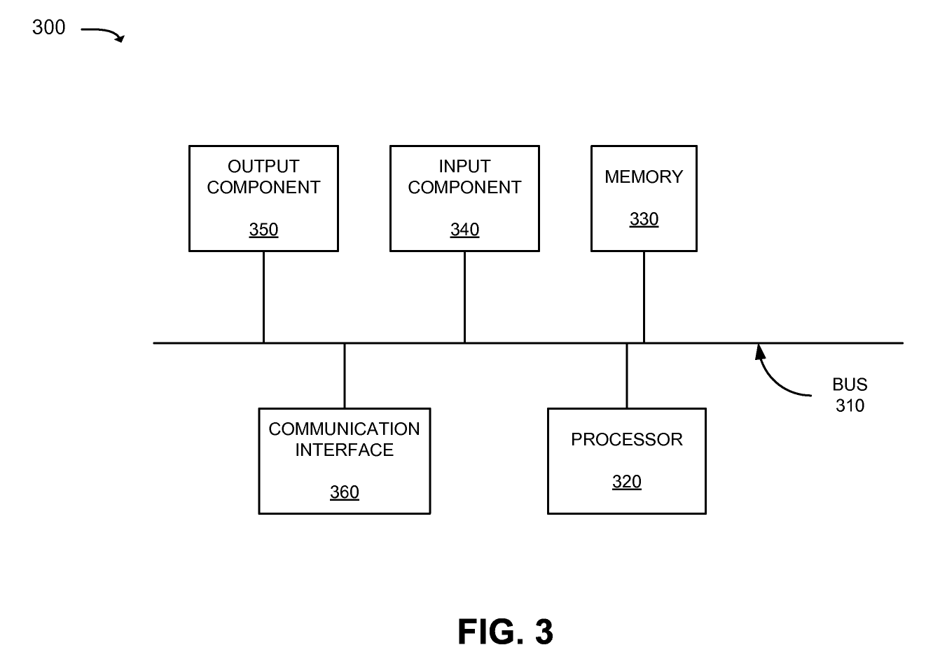

FIG. 3 is a diagram of exemplary components of a device 300 that may correspond to local server 220, global server 230, and/or global backup server 240. Device 300 may include a bus 310, a processor 320, a memory 330, an input component 340, an output component 350, and a communication interface 360. Although FIG. 3 shows exemplary components of device 300, in other implementations, device 300 may contain fewer components, additional components, different components, or differently arranged components than depicted in FIG. 3. Additionally, or alternatively, in other implementations, one or more components of device 300 may perform one or more tasks described as being performed by one or more other components of device 300.

Bus 310 may include a path that permits communication among the components of device 300. Processor 320 may include a processor, microprocessor, or processing logic that may interpret and execute instructions. Memory 330 may include any type of dynamic storage device that may store information and instructions for execution by processor 320, and/or any type of non-volatile storage device that may store information for use by processor 320.

Input component 340 may include a mechanism that permits a user to input information to device 300, such as a keyboard, a keypad, a button, a switch, etc. Output component 350 may include a mechanism that outputs information to the user, such as a display, a speaker, one or more light emitting diodes (LEDs), etc. Communication interface 360 may include any transceiver-like mechanism that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.) or a combination of wireless and wired communications. For example, communication interface 360 may include mechanisms for communicating with another device or system via a network, such as network 260 and/or local network 270.

As will be described in detail below, device 300 may perform certain operations relating to an automatic user device backup operation. Device 300 may perform these operations in response to processor 320 executing software instructions contained in a computer-readable medium, such as memory 330. A computer-readable medium may be defined as a physical or logical memory device. A logical memory device may include memory space within a single physical memory device or spread across multiple physical memory devices. The software instructions may be read into memory 330 from another computer-readable medium or from another device. The software instructions contained in memory 330 may cause to processor 320 to perform processes described herein. Alternatively, hardwired circuitry may be used in place of or in combination with software instructions to implement processes described herein. Thus, implementations described herein are not limited to any specific combination of hardware circuitry and software.

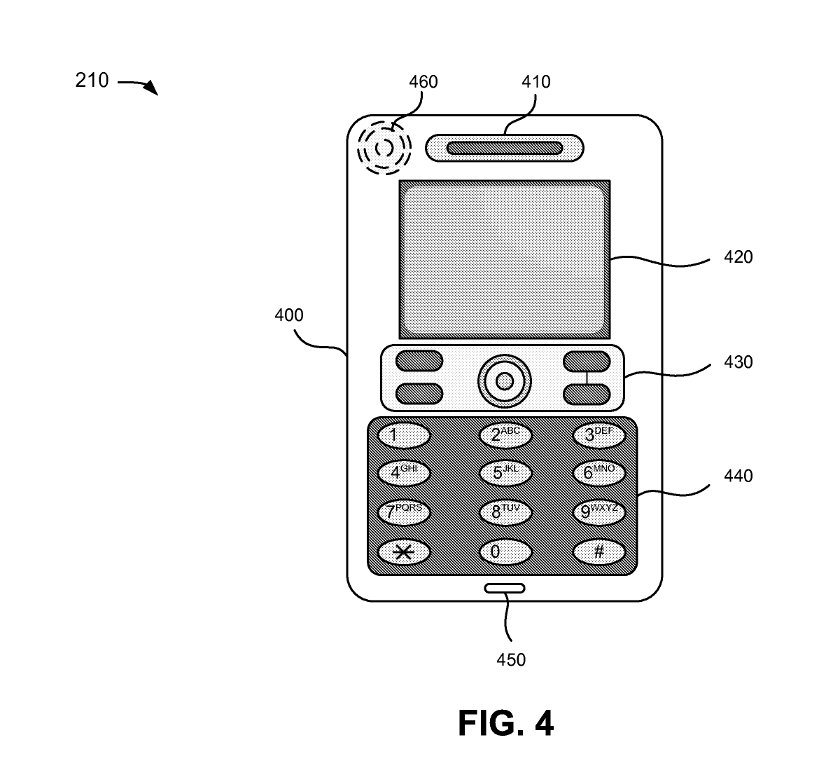

FIG. 4 is a diagram of an exemplary user device 210. As shown in FIG. 4, user device 210 may include a housing 400, a speaker 410, a display 420, control buttons 430, a keypad 440, a microphone 450, and/or a camera 460. Housing 400 may include a chassis on which some or all of the components of user device 210 are mechanically secured and/or covered. Speaker 410 may include a component to receive input electrical signals from user device 210 and transmit audio output signals, which communicate audible information to a user of user device 210.

Although FIG. 4 depicts exemplary components of user device 210, in other implementations, user device 210 may contain fewer components, additional components, different components, or differently arranged components than illustrated in FIG. 4. In still other implementations, one or more components of user device 210 may perform one or more tasks described as being performed by one or more other components of user device 210.

Display 420 may include a component to receive input electrical signals and present a visual output in the form of text, images, videos and/or combinations of text, images, and/or videos which communicate visual information to the user of user device 210. In one implementation, display 420 may display text input into user device 210, text, images, and/or video received from another device, and/or information regarding incoming or outgoing calls or text messages, emails, media, games, phone books, address books, the current time, etc.

Control buttons 430 may include one or more buttons that accept, as input, mechanical pressure from the user (e.g., the user presses a control button or combinations of control buttons) and may send electrical signals to processing unit 320 that may cause user device 210 to perform one or more operations. For example, control buttons 430 may be used to cause user device 210 to transmit information. Keypad 440 may include a standard telephone keypad or another arrangement of keys.

Microphone 450 may include a component to receive audible information from the user and send, as output, an electrical signal that may be stored by user device 210, transmitted to another user device, or cause the device to perform one or more operations. Camera 460 may be provided on a back side of user device 210, and may include a component to receive, as input, analog optical signals and send, as output, a digital image or video that can be, for example, viewed on the display 410, stored in the memory of user device 210, discarded and/or transmitted to another user device 210.

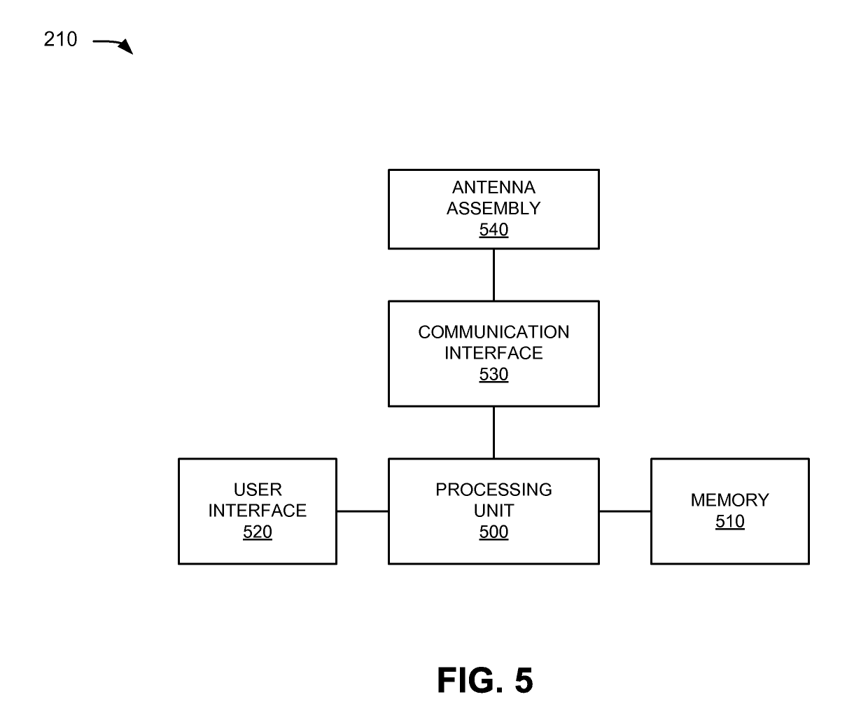

FIG. 5 is a diagram of exemplary components of user device 210. As shown in FIG. 5, user device 210 may include a processing unit 500, a memory 510, a user interface 520, a communication interface 530, and/or an antenna assembly 540. Although FIG. 5 shows exemplary components of user device 210, in other implementations, user device 210 may contain fewer components, additional components, different components, or differently arranged components than depicted in FIG. 5. In still other implementations, one or more components of user device 210 may perform one or more tasks described as being performed by one or more other components of user device 210.

Processing unit 500 may include a processor, a microprocessor, an ASIC, a FPGA, or the like. Processing unit 500 may control operation of user device 210 and its components. In one implementation, processing unit 500 may control operation of components of user device 210 in a manner similar to that described herein. Memory 510 may include a RAM, a ROM, and/or another type of memory to store data and/or instructions that may be used by processing unit 500.

User interface 520 may include mechanisms for inputting information to user device 210 and/or for outputting information from user device 210. Examples of input and output mechanisms might include buttons (e.g., control buttons 430, keys of keypad 440 or a keyboard, a joystick, etc.); a touch screen interface to permit data and control commands to be input into user device 210; a speaker (e.g., speaker 410) to receive electrical signals and output audio signals; a microphone (e.g., microphone 450) to receive audio signals and output electrical signals; a display (e.g., display 420) to output visual information (e.g., a backup preferences user interface, web pages, etc.); a vibrator to cause user device 210 to vibrate; and/or a camera (e.g., camera 460) to receive video and/or images.

Communication interface 530 may include, for example, a transmitter that may convert baseband signals from processing unit 500 to radio frequency (RF) signals and/or a receiver that may convert RF signals to baseband signals. Alternatively, communication interface 530 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications. Communication interface 530 may connect to antenna assembly 540 for transmission and/or reception of the RF signals.

Antenna assembly 540 may include one or more antennas to transmit and/or receive RF signals over the air. Antenna assembly 540 may, for example, receive RF signals from communication interface 530 and transmit them over the air, and receive RF signals over the air and provide them to communication interface 530. In one implementation, for example, communication interface 530 may communicate with a network and/or devices connected to a network (e.g., network 260 and/or local network 270).

As described in detail below, user device 210 may perform certain operations described herein in response to processing unit 500 executing software instructions of an application contained in a computer-readable medium, such as memory 510. The software instructions may be read into memory 510 from another computer-readable medium or from another device via communication interface 530. The software instructions contained in memory 510 may cause processing unit 500 to perform processes that will be described later. Alternatively, hardwired circuitry may be used in place of or in combination with software instructions to implement processes described herein. Thus, implementations described herein are not limited to any specific combination of hardware circuitry and software.

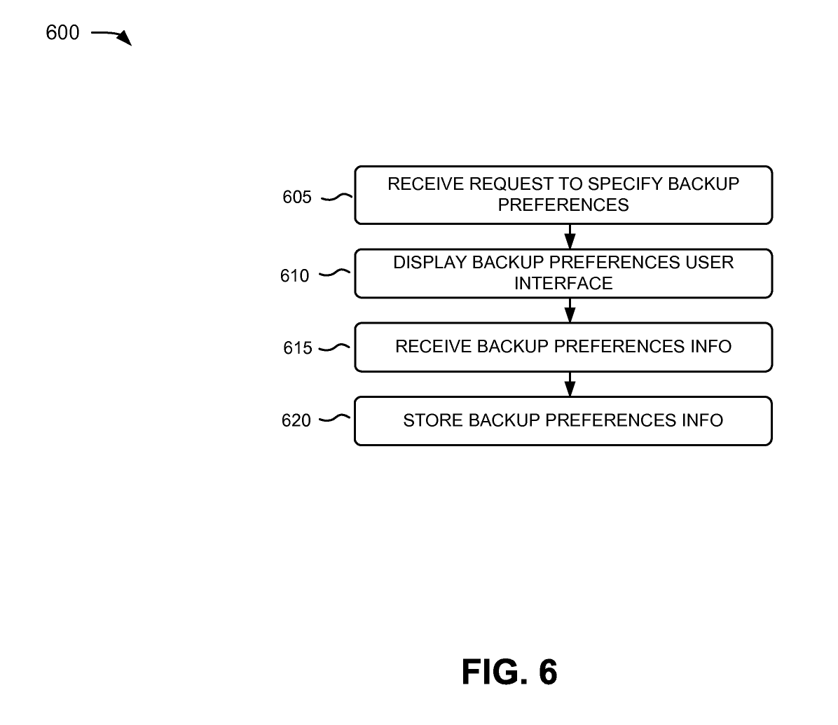

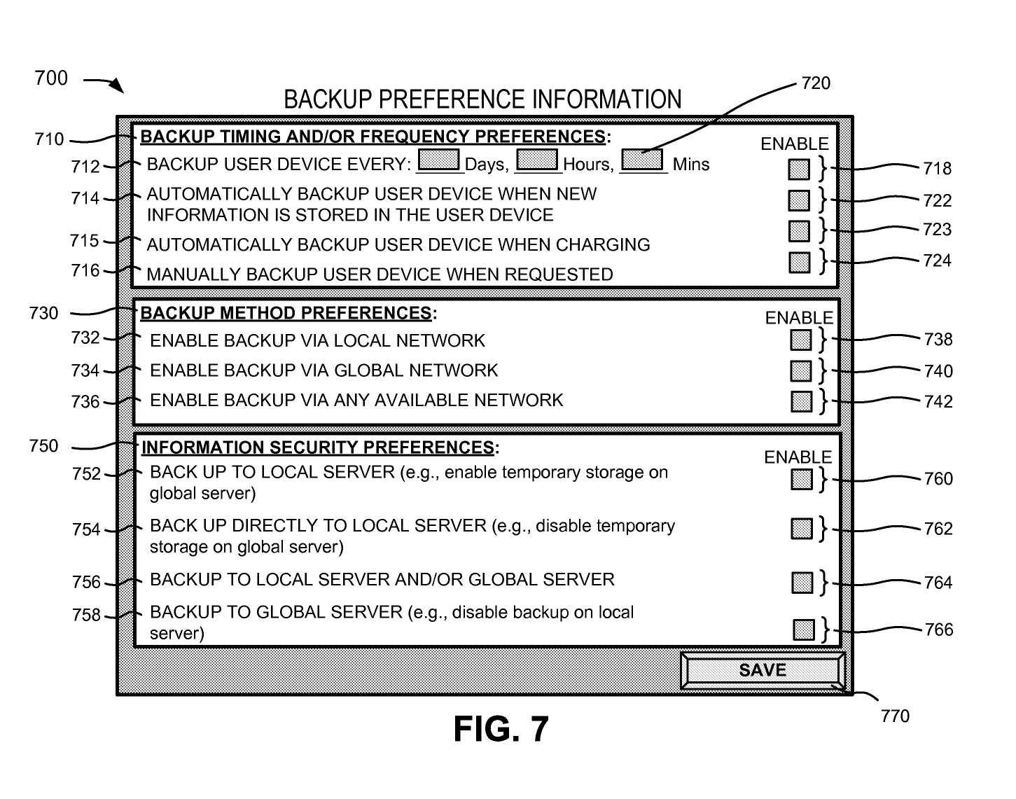

FIG. 6 is a flowchart of an exemplary process 600 for specifying backup preferences within an exemplary portion of network 200. In one implementation, process 600 may be performed by user device 210. In another implementation, some or all of process 600 may be performed by a device or collection of devices separate from, or in combination with, user device 210. FIG. 7 is a diagram of an exemplary backup preferences user interface 700 that is capable of being presented on user device 210. A portion of process 600, of FIG. 6, will be discussed below with corresponding references to back up preferences user interface 700 shown in FIG. 7.

Process 600 of FIG. 6 may include receiving a request to specify backup preferences (block 605). For example, a user, of user device 210, may desire to specify back up preferences that govern the manner in which backup operations are performed on user device 210. The user may request to set up backup preferences by pressing a particular button, or combination of buttons, on user device 210. User device 210 may receive the request and may retrieve a backup application from a memory (e.g., a memory associated with user device 210).

A backup preferences user interface may be displayed (block 610). For example, the backup application may retrieve, from the memory, information associated with a backup preferences user interface and may present the information associated with the backup preferences user interface for display on the display (e.g., display 420 of FIG. 4) of user device 210. In one implementation, backup preferences user interface may correspond to backup preferences user interface 700 of FIG. 7. For example, backup preferences user interface 700 may include backup timing and/or frequency preferences 710, backup method preferences 730, and/or information security preferences 750.

Backup timing and/or frequency preferences 710 may include a preference to backup the user device (e.g., user device 210) based on a user-specified time period 712, a preference to automatically backup the user device when new information is stored by the user device 714, a preference to automatically backup the user device when the user device is in a particular state (e.g. a charging state) 715, and/or a preference to manually backup the user device when requested by the user 716 (e.g., when the user presses a button, or combination of buttons, on user device 210). Additionally, or alternatively, the preference to manually backup the user device 716 could be performed in combination with the preference to automatically backup the user device based on the user-specified time period 712 and/or the preference to automatically backup the user device when new information is stored by the user device 714.

Backup method preferences 730 may include a preference to enable backup operations to be performed via a local network 732 (e.g., local network 270), such as a wired LAN and/or wireless LAN (e.g., Wi-Fi network); a preference to enable backup operations via a global network 734 (e.g., network 260), such as a service provider network and/or the Internet; and/or a preference to enable backup operations via the local network, the global network, and/or any available network 736.

Information security preferences 750 may include a preference that enables the user device (e.g., user device 210) to be backed up to a local server (e.g., local server 220) and/or that temporary storage, via a global server (e.g., global server 230), be enabled 752. In another example, information security preferences 750 may include a preference that enables the user device to be backed up directly to the local server and/or that temporary storage, via the global server, be disabled 754. In yet another example, information security preferences 750 may include a preference that enables the user device to be backed up to either the local server and/or the global server 756. In still another example, information security preferences 750 may include a preference that enables the user device to be backed up to the global server and/or a global backup server (e.g., global backup server 240) and/or that backing up the user device to the local server be disabled 758.

Backup preferences information may be received (block 615). For example, the user may specify the backup preferences information, via the backup preferences user interface (e.g., backup preferences user interface 700 of FIG. 7) and the backup preferences information may be received by user device 210.

The user may specify desired timing and/or frequency preferences 710 for backup operations to be performed. For example, the user may enable backup operations to be performed based on a particular time interval 712, by placing an “X” (e.g., “selecting”) in the corresponding enable box 718. The user may specify a particular backup time interval by which automatic backup operations are triggered by inserting the desired time interval (e.g., in days, hours, minutes, seconds, etc.) into boxes 720. In another example, the user may enable automatic backup operations to be performed when new information is stored by the user device 714 by selecting the corresponding enable box 722. In yet another example, the user may enable automatic backup operations to be performed when the user device is in a particular state, such as when the user device is charging, by selecting the corresponding enable box 723. In still another example, the user may enable backup operations to be performed manually 716 by selecting the corresponding enable box 724. If the user does not specify backup timing and/or frequency preferences 710, then the backup application may, as a default, automatically backup the user device when new content is stored to the user device 714.

The user may indicate the desired backup method preferences 730 that backup operations are to be performed. For example, the user may enable backup operations to be performed, via the local network (e.g., local network 270), by selecting the corresponding enable box 738. In another example, the user may enable backup operations to be performed, via a global network (e.g., network 260), by selecting the corresponding enable box 740. In yet another example, the user may enable backup operations to be performed, via either the local network, global network, and/or any available network, by selecting the corresponding enable box 742. If the user does not specify backup method preferences 730, then the backup application may select one of the backup method preferences as a default.

The user may indicate the desired information security preferences 750 that backup operations are to be performed. For example, the user may enable information to be backed up to the local server (e.g., local server 220), while permitting temporary storage via the global server 752 (e.g., global server 230), by selecting in the corresponding enable box 760. In another example, the user may enable information to be backed up to the local server, while disabling temporary storage via the global server 754, by selecting the corresponding enable box 762. In yet another example, the user may enable information to be backed up to either the local server and/or the global server 756 by selecting the corresponding enable box 764. In still another example, the user may enable information to be backed up to a global backup server (e.g., global backup server 240), while disabling backup operations to the local server 758, by selecting the corresponding enable box 766. If the user does not specify information security preferences 750, then the backup application may select one of the information security preferences as a default.

While FIG. 7 illustrates backup preferences information that includes preferences 712-716, 732-736, and 752-758, in another implementation, backup preferences information may include fewer preferences, additional preferences, different preferences, or differently arranged preferences than are described with respect to FIG. 7.

Backup preferences information may be stored (block 620). For example, when the user has completed specifying backup preferences information, via the backup preferences user interface, the user may save the backup preferences information (e.g., by selecting the “save” button 770). User device 210 may, in response to the request to save the backup preferences information, store the backup preferences information in a memory associated with user device 210.

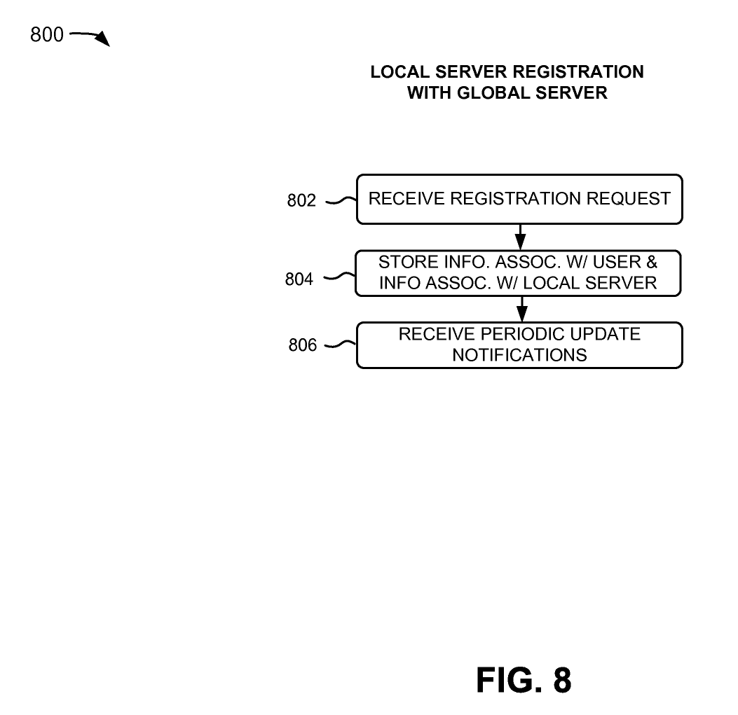

FIG. 8 is a flowchart of an exemplary process 800 for registering local server 220 with global server 230 within network 200. In one implementation, process 800 may be performed by local server 220 and global server 230. In another implementation, some or all of process 800 may be performed by a device or collection of devices separate from, or in combination with, local server 220 and global server 230.

Process 800 may include receiving a registration request (block 802). For example, local server 220 may send a registration request to global server 230 and global server 230 may receive the registration request. The registration request may include information associated with a user of user device 210 (e.g., username, password, PIN, email address, etc.), information associated with local server 220 (e.g., a local server 220 identifier, an address associated with local server 220, etc.), and/or information associated with user device 210 (e.g. an identifier associated with user device 210).

Information associated with the user and information associated with local server 220 may be stored (block 804). For example, global server 230 may receive the registration request and may store, in a memory associated with global server 230, the information associated with the user and information associated with local server 220.

Periodic status notifications may be received (block 806). For example, global server 230 may receive periodic status notifications (e.g., every 5 minutes, 1 minute, 30 seconds, etc.) from local server 220 that may indicate that local server 220 is online, is available, and/or is otherwise able to perform backup operations. The periodic status notifications may include information associated with the user, information associated with local server 220, and/or information associated with user device 210.

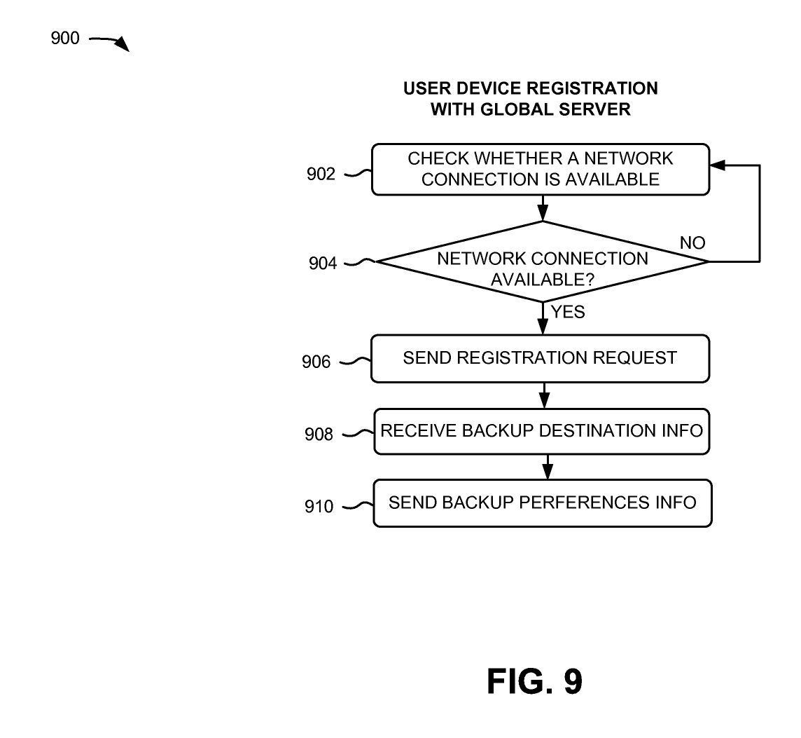

FIG. 9 is a flowchart of an exemplary process 900 for registering user device 210 with global server 230 within network 200. In one implementation, process 900 may be performed by user device 210 and global server 230. In another implementation, some or all of process 900 may be performed by a device or collection of devices separate from, or in combination with, user device 210 and global server 230.

Process 900 may include checking whether a network connection is available (block 902). For example, user device 210 may transmit a hello notification (e.g., a ping and/or another message) to determine whether a network connection is available via network 260, local network 270, and/or another network.

If a network connection is not available (block 904—NO), then process 900 may continue to check whether a network connection is available (block 902). For example, user device 210 may not receive a return hello notification (e.g., a return ping and/or another return message) indicating that a network is available and may continue to periodically and/or intermittently send hello notifications to determine whether a network becomes available.

If a network connection is available (block 904—YES), then a registration request may be sent (block 906). For example, user device 210 may receive a hello notification, in response to the sent hello notification, from a network (e.g., network 260, local network 270 and/or the other network). User device 210 may send a registration request to global server 230. The request may include information associated with the user of user device 210 (e.g., username, password, PIN, email address, etc.), information associated with local server 220 (e.g., local server 220 identifier), and/or information associated with user device 210 (e.g., an identifier associated with user device 210).

Backup destination information may be received (block 908). For example, global server 230 may receive the registration request and may authenticate user device 210. Global server 230 may compare information associated with the user, information associated with user device 210, and/or information associated with local server 220 retrieved from a memory (e.g., a memory associated with global server 230) with information associated with the user, information associated with user device 210, and/or information associated with local server 220 received from user device 210. Global server 230 may authenticate user device 210 if information associated with the user, information associated with user device 210, and/or information associated with local server 220, retrieved from the memory, matches information associated with the user, information associated with user device 210, and/or information associated with local server 220 received from user device 210. Global server 230 may send backup destination information (e.g. an IP address), associated with local server 220 and/or global backup server 240, to user device 210. User device 210 may receive the backup destination information associated with local server 220 and/or global backup server 240 and may store the backup destination information, associated with local server 220 and/or global backup server 240, in a memory (e.g., a memory associated with user device 210).

Backup preferences information may be sent (block 910). For example, user device 210 may retrieve backup preferences information from the memory (e.g., the memory associated with user device 210) and may send the backup preferences information to global server 230. Global server 230 may receive the backup preferences information and may store the backup preferences information in the memory associated with global server 230.

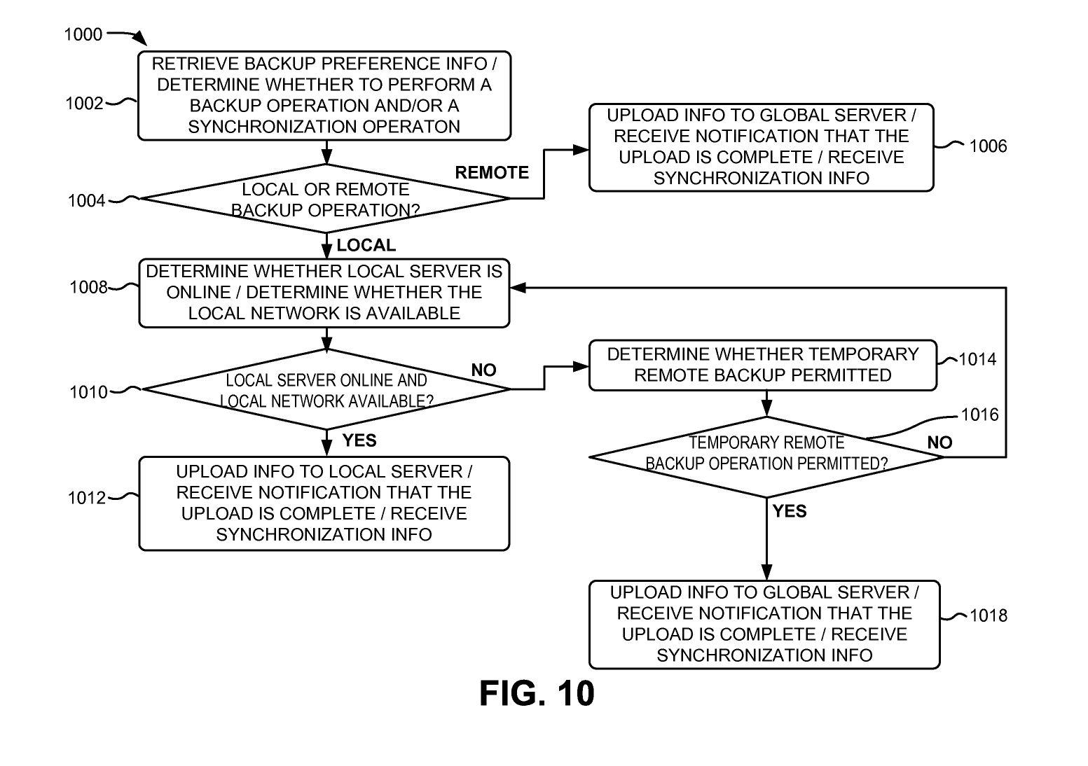

FIG. 10 is a flowchart of an exemplary process 1000 for automatically backing up user device 210 within network 200. In one implementation, process 1000 may be performed by user device 210, local server 220, global server 230, and global backup server 240. In another implementation, some or all of process 1000 may be performed by a device or collection of devices separate from, or in combination with, user device 210, local server 220, global server 230, and global backup server 240.

Process 1000 may include retrieving backup preferences information and determining whether to perform a backup operation and/or a synchronization operation (block 1002). Assume that local server 220 has registered with global server 230, in a manner similar to that described above with respect to process 800 of FIG. 8. Assume further that a user (e.g., a user of user device 210) has specified backup preferences information in a manner similar to that described above with respect to process 600 of FIG. 6. Assume still further that user device 210 has registered with global server 230 and that the backup preferences information has been sent to global server 230, in a manner similar to that described above with respect to process 900 of FIG. 9.

Backup preferences information (e.g., backup preferences information associated with backup preferences user interface 700 of FIG. 7) may be retrieved from a memory (e.g., a memory associated with user device 210) and, from the backup preferences information, user device 210 may determine whether to perform an automatic backup operation. In one example, from the backup preferences information, user device 210 may determine that an automatic backup operation is to be performed based on a particular time interval as specified by the user (e.g., every two hours, every day, every ninety minutes, etc.). In this example, user device 210 may read the particular time interval from the user preferences and may determine whether new information has been stored, in the memory, after a particular time corresponding to when a previous backup operation was performed. User device 210 may compute a time period from the particular time to the present time and may determine that an automatic backup operation is to be performed with the time period is equal to or greater than the particular time interval.

In another example, user device 210 may determine that the user desires that a backup operation be performed when new information (e.g., information that has not been previously backed up) is stored by user device 210. In this example, user device 210 may store new information in a memory (e.g., associated with user device 210) and may add a file identifier (e.g., a file name, file number, and/or some other identifier), associated with the new information, to an upload list. User device 210 may perform an automatic backup operation based on the file identifier stored in the upload list. In another example, user device 210 may perform a synchronization operation. User device 210 may communicate with local server 220, global server 230, and/or global backup server 240 to determine whether any files, stored on user device 210, have not been backed up to local server 220, global server 230, and/or backup server 240. User device 210 may determine that files, stored on user device 210 have not been backed up to local server 220, global server 230 and/or global backup server 240 and an automatic backup operation may be triggered by user device 210.

In yet another example, the user may press a particular button, or combination of buttons, on user device 210, to perform a manual backup operation of information stored by user device 210.

If the backup operation is a remote backup operation (block 1004—REMOTE), then information may be uploaded to a global server, a notification that the upload is complete may be received, and/or synchronization information may be received (block 1006). For example, user device 210 may, from the backup preferences information, determine that the user has specified that user device 210 is to be backed up remotely. User device 210 may send a notification, to global server 230 and via a public network (e.g., network 260), indicating that a backup operation is to be performed. The notification may include a list of file identifiers associated with information stored by user device 210. In this example, global server 230 may receive the notification and may compare the list of file identifiers to another list of file identifiers stored in a memory (e.g., a memory associated with global server 230). Global server 230 may determine whether particular file identifiers, from the list of file identifiers, match any of the file identifiers from the other list of file identifiers stored in the memory. Global server 230 may send, to user device 210 and via the public network, an upload list that includes the particular file identifiers that do not match any of the file identifiers from the other list of file identifiers stored in the memory (e.g., file identifiers corresponding to files that have not yet been backed up).

User device 210 may send information to global server 230. For example, user device 210 may send information, associated with the particular file identifiers, to global server 230, via the global network, in response to the upload list received from global server 230. Global server 230 may receive the information and may send a notification to user device 210 when information associated with the upload list has been received. Global server 230 may temporarily store the information in a memory associated with global server 230. Global server 230 may receive a status notification from global backup server 240 and may send a download notification to global backup server 240, in response to the status notification, indicating that information is ready to be downloaded. Global backup server 240 may, in response to the download notification, retrieve the information and/or may store the retrieved information in database 250.

In another example, user device 210 may retrieve timestamp information associated with a particular time at which the most recent backup operation was performed by user device 210. Based on the timestamp information, user device 210 may retrieve information stored by user device 210 after the particular time and may send the retrieved information to global server 230. In yet another example, user device 210 may index and/or store pending information (e.g., information that is not yet backed up) to a memory and may upload the pending information based on the index during another backup operation (e.g., at a future point in time).

In another implementation, user device 210 may upload information directly to global backup server 240 via the public network. For example, user device 210 may send a notification to global server 230, via the public network (e.g., network 260) to perform a remote backup operation. Global server 230 may receive the notification and may check to determine whether global backup server 240 is online, is available and/or is otherwise operational. If global server 230 determines that global backup server 240 is online, is available, and/or is otherwise operational (e.g., by checking whether status notifications are being received from global backup server 240), then global server 230 may send, to user device 210 via the global network, an address associated with global backup server 240. User device 210 may receive the address and may send an upload list and/or information to global backup server 240 in a manner similar to that described above.

Global backup server 240 may perform a synchronization operation. For example, global backup server 240, may receive information associated with file identifiers, as discussed above, and may store, in a memory, some or all of the information associated with the file identifiers. Global backup server 240 may send, to user device 210, a notification indicating that the upload operation is complete which may include synchronization information. The synchronization information may include particular file identifiers that correspond to some or all of the information stored in the memory. User device 210 may receive the particular file identifiers and may synchronize the information stored on user device 210 by removing the particular file identifiers from the upload list and/or marking the particular file identifiers as having been backed up and/or having been uploaded.

If the backup operation is a local backup operation (block 1004—LOCAL), then it may be determined whether the local server is online and whether the local network is available (block 1008). For example, user device 210 may, from the backup preferences information, determine that the user has specified that user device 210 is to be backed up locally (e.g., on local server 220). User device 210 may send a notification, to global server 230 via a public network (e.g., network 260), to perform a local backup operation. Global server 230 may receive the notification and may check to determine whether local server 220 is online, is available, and/or is otherwise operational (e.g., by checking whether status notifications are being received from local server 220). Additionally, or alternatively, user device 210 may determine whether a private network associated with local server 220 (e.g., local network 270) is available. For example, user device 210 may transmit a hello notification (e.g., a ping and/or hello message) to determine whether local network 270 is available.

If the local server is online and if the local network is available (block 1010—YES), then information may be uploaded to the local server, a notification that the upload is complete may be received, and/or synchronization information may be received (block 1012). For example, global server 230 may determine that status notifications are being received from local server 220 and may send a notification to user device 210 indicating that local server 220 is online and/or is available. Additionally, or alternatively, user device 210 may receive a return hello notification (e.g., a return ping and/or another return message) from local network 270 and may determine that local network 270 is available.

User device 210 may send a notification, to local server 220 and via the private network (e.g., local network 270), indicating that a local backup operation is to be performed. For example, in a manner similar to that described above (with respect to block 1006), the notification may include a list of file identifiers associated with information stored by user device 210 memory. Local server 220 may receive the notification and may send an upload list to user device 210 via the private network. The upload list may contain particular file identifiers that do not match any of the file identifiers stored in local server 220 memory. User device 210 may send information, corresponding to the particular file identifiers, to local server 220 via the private network and local server 220 may send a notification to user device 210 when the upload is complete. Local server 220 may store the information in a memory (e.g., a memory associated with local server 220).

In another example and in a manner similar to that described above (with respect to block 1006), user device 210 may retrieve timestamp information associated with a particular time at which the most recent backup operation was performed by user device 210. Based on the timestamp information, user device 210 may retrieve information stored by user device 210 after the particular time and may send the retrieved information to local server 220 via a private network (e.g., local network 270). Local server 220 may store the information in a memory (e.g., a memory associated with local server 220).

Local server 220 may perform a synchronization operation. For example, local server 220, may receive information associated with file identifiers, as discussed above, and may store some or all of the information associated with the file identifiers. Local server 220 may send, to user device 210, a notification indicating that the upload operation is complete, which may include synchronization information. The synchronization information may include particular file identifiers that correspond to some or all of the information stored in the memory. User device 210 may receive the particular file identifiers and may synchronize the information stored on user device 210 by removing the particular file identifiers from the upload list and/or marking the particular file identifiers as having been backed up and/or having been uploaded.

If the local server is not online or if the local network is not available (block 1010—NO), then it may be determined whether temporary remote backup is permitted (block 1014). For example, global server 230 may determine that status notifications are not being received from local server 220 and may send a notification to user device 210 indicating that local server 220 is offline and/or is otherwise unavailable. Additionally, or alternatively, user device 210 may not receive a return hello notification (e.g., a return ping and/or another return message) from local network 270 and may determine that local network 270 is not available.

User device 210 may determine whether a temporary remote backup operation is permitted. For example, user device 210 may, from the backup preferences information, determine whether the user permits information to be temporarily backed up, via global server 230, when local server 220 is offline and/or if local network 270 is not available.

In another implementation, global server 230 may determine whether a temporary remote backup operation is permitted. For example, user device 210 may send a request to perform a backup operation to global server 230 based on the determination that local server 220 is offline and/or that local network 270 is not available. Global server 230 may receive the request and may, from the backup preferences information stored in memory, determine whether the user permits information to be temporarily backed up, via global server 230, when local server 220 is offline and/or if local network 270 is not available.

If a temporary remote backup operation is permitted (block 1016—YES), then information may be uploaded to the global server, a notification that the upload is complete may be received, and/or synchronization information may be received (block 1018). For example, user device 210 may, from the backup preferences information, determine that the user desires that information be temporarily backed up, via global server 230, when local server 220 is offline and/or when local network 270 is not available. User device 210 may send information and/or a list of file identifiers (e.g., a list file names associated with information stored by user device 210) to global server 230 via a public network (e.g., network 260). Global server 230 may receive the information and/or list of file identifiers and may temporarily store the information and/or list of file identifiers in a memory (e.g., a memory associated with global server 230).

Global server 230 may perform a synchronization operation. For example, global server 230, may receive information associated with the file identifiers, as discussed above, and may store some or all of the information associated with the file identifiers. Global server 230 may send, to user device 210, a notification indicating that the upload operation is complete and may communicate with user device 210 to perform a synchronization operation in a manner similar to that described above (with respect to blocks 1006 and 1012).

User device 210 may receive particular file identifiers from global server 230 (e.g., as a result of the synchronization operation) that correspond to files that have been backed up and may synchronize the information, stored on user device 210, by removing the particular file identifiers from the upload list, may remove the file identifiers from an index, and/or may mark the particular file identifiers as having been backed up. Additionally, or alternatively, if user device 210 determines that particular file identifiers, received from global server 230, correspond to files that are stored in global server 230 memory that are not stored in user device 210 memory, then user device 210 may send an instruction, to global server 230, to delete the files associated with the particular file identifiers and/or may send a request to download the files corresponding to the particular file identifiers.

At some later point in time, local server 220 may send a status notification to global server 230 and global server 230 may, in response to the status notification, send a download notification indicating that information, associated with user device 210, may be downloaded. Local server 220 may receive the download notification and may download, from global server 230, the information and/or the list of file identifiers. In one example, a manner similar to that described above (with respect to 1006), local server 220 may compare the list of file identifiers with another list of file identifiers stored in a memory (e.g., a memory associated with local server 220). Local server 220 may store, in the memory, the information corresponding to the particular file identifiers that do not match any of the file identifiers, of the other list of file identifiers, stored in the memory.

In another example, in a manner similar to that described above (with respect to block 1006), local server 220 may store information that was stored by user device 210 after the particular time at which the previous backup operation was performed.

If a temporary remote backup operation is not permitted (block 1016—NO), then it may be determined whether the local server is online and whether the local network is available (block 1008). For example, user device 210 may, from the backup preferences information, determine that the user has specified that a temporary remote backup operation is not permitted. In this example, user device 210 may periodically send hello notifications to a private network associated with local server 220 (e.g., local network 270) to determine whether the private network becomes available. Additionally, or alternatively, user device 210 may periodically send a notification to global server 230 to perform a local backup operation. Global server 230 may receive the notification and may check to determine whether local server 220 is online, is available, and/or is otherwise operational.

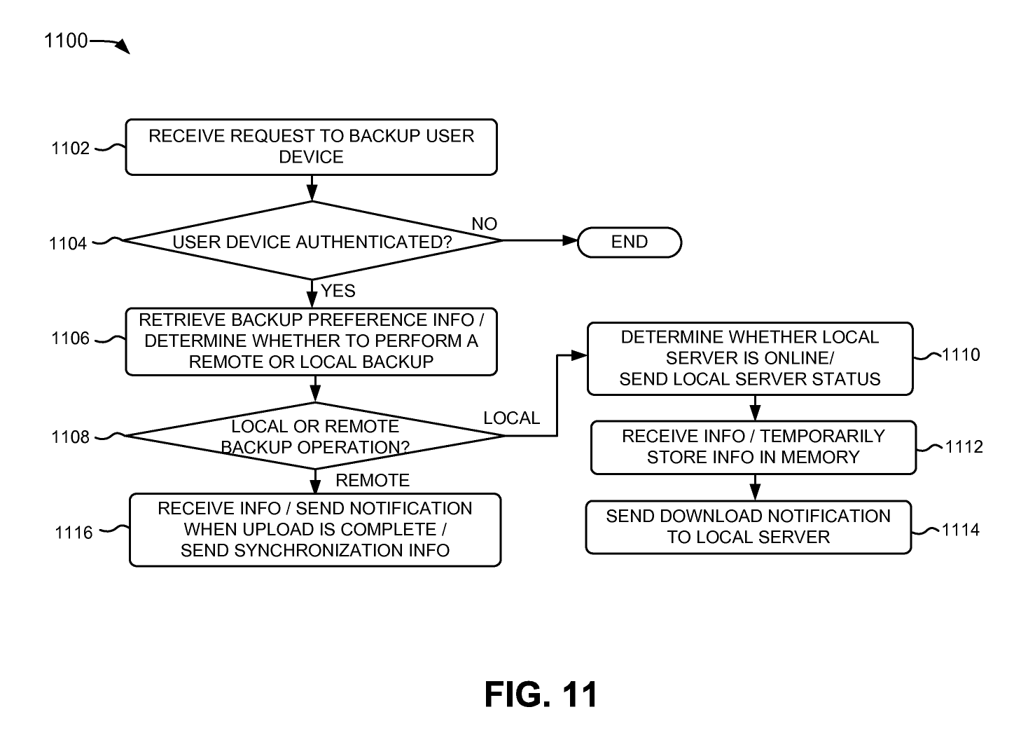

FIG. 11 is a flowchart of another exemplary process 1100 for automatically backing up user device 210 within network 200. In one implementation, process 1100 may be performed by user device 210, local server 220, global server 230, and/or global backup server 240. In another implementation, some or all of process 1100 may be performed by a device or collection of devices separate from, or in combination with, user device 210, local server 220, global server 230, and/or global backup server 240.

Process 1100 may include receiving a request to backup a user device (block 1102). For example, global server 230 may receive a request from user device 210 to perform a backup operation on user device 210. The request may include information associated with the user of user device 210 (e.g., username, password, PIN, email address, etc.), information associated with user device 210 (e.g., an identifier associated with user device 210), and/or information associated with local server 220 (e.g., local server 220 identifier). Global server 230 may receive the request and may authenticate user device 210. Global server 230 may compare information associated with the user, information associated with user device 210, and/or information associated with local server 220 retrieved from a memory (e.g., a memory associated with global server 230) with information associated with the user, information associated with user device 210, and/or information associated with local server 220 received from user device 210.

In another implementation, global server 230 may trigger a backup operation. For example, global server 230 may read a particular time interval, from the user preferences, associated with user device 210, stored in a memory (e.g., a memory associated with global server 230). From the particular time interval, global server 230 may determine that an automatic backup operation is to be performed on user device 210. Global server 230 may determine that a previous backup operation was performed at a particular time and may compute a time period from the particular time to the present time. Global server 230 may send a notification to user device 210 to initiate a backup operation when the time period is equal to or greater than the particular time internal.

If the user device is not authenticated (block 1104—NO), then a backup operation may not be performed and/or process 1100 may end. For example, global server 230 may not authenticate user device 210 if information associated with the user, information associated with user device 210, and/or information associated with local server 220, retrieved from the memory, does not match information associated with the user, information associated with user device 210, and/or information associated with local server 220 received from user device 210. Global server 230 may not perform a backup operation for user device 210 and/or process 1100 may end based on the determination that user device 210 cannot be authenticated.

If the user device is authenticated (block 1104—YES), then backup preferences information may be retrieved and it may be determined whether to perform remote or local backup operation (block 1106). For example, global server 230 may authenticate user device 210 if information associated with the user, information associated with user device 210, and/or information associated with local server 220, retrieved from the memory, matches information associated with the user, information associated with user device 210, and/or information associated with local server 220 received from user device 210. Global server 230 may retrieve backup preferences information from memory and may determine whether the user has enabled remote backup operations and/or local backup operations.

If the backup operation is a local backup operation (block 1108—LOCAL), then it may be determined whether the local server is online and a local server status notification may be sent (block 1110). For example, global server 230 may determine, from the backup preferences information, that the user has specified that user device 210 is to be backed up to local server 220 by performing a local backup operation. Global server 230 may check to determine whether global server 230 is receiving status notifications from local server 220 and may send a status notification, to user device 210, indicating whether local server 220 is online and/or is available.

In one example, if global server 230 determines that local server 220 is online and/or is available (e.g., status notifications are being received from local server 220), then a status notification, indicating that local server 220 is online and/or is available, may be sent to user device 210. User device 210 may receive the status notification and may communicate directly with local server 220, via a private network (e.g., local network 270) to permit information to be backed up to local server 220. In this example, user device 210 may send information to local server 220 in a manner similar to that described above (with respect to block 1012 of FIG. 10).

In another example, if global server 230 determines that local server 220 is not online (e.g., offline) and/or is unavailable (e.g., status notification are not being received) then a status notification may be sent to user device 210 indicating that local server 220 is offline or is otherwise not available.

Information may be received and information may be temporarily stored in memory (block 1112). For example, global server 230 may receive information and a list of file identifiers associated with the information from user device 210 via a public network (e.g., network 260). Global server 230 may temporarily store the list of file identifiers and the information in a memory (e.g., a memory associated with global server 230).

A download notification may be sent to the local server (block 1114). For example, at some later point in time, global server 230 may receive a status notification from local server 220 and may send a download notification to local server 220 indicating that information is temporarily stored and available to be downloaded. In response to the download notification, local server 220 may download the list of file identifiers and the information from global server 230. Local server 220 may compare the list of file identifiers with another list of file identifiers stored in memory (e.g., a memory associated with local server 220). Local server 220 may store the information corresponding to particular file identifiers that do not match the file identifiers stored in the memory associated with local server 220.

Local server 220 may perform a synchronization operation. For example, local server 220, may receive information associated with the file identifiers, as discussed above, and may store some or all of the information associated with the file identifiers. Local server 220 may send, to user device 210, a notification indicating that the upload operation is complete and may communicate with user device 210, when the local server is back online, to perform a synchronization operation in a manner similar to that described above (with respect to blocks 1006 and 1012 of FIG. 10).

User device 210 may receive particular file identifiers from local server 220 (e.g., as a result of the synchronization operation) that correspond to files that have been backed up and may synchronize the information, stored on user device 210, by removing the particular file identifiers from the upload list, may remove the file identifiers from an index, and/or may mark the particular file identifiers as having been backed up. Additionally, or alternatively, if user device 210 determines that particular file identifiers, received from local server 220, correspond to files that are stored in local server 220 memory that are not stored in user device 210 memory, then user device 210 may send an instruction, to local server 220, to delete the files associated with the particular file identifiers and/or may send a request to download the files corresponding to the particular file identifiers.

If the backup operation is a remote backup operation (block 1108—REMOTE), then information may be received, a notification when the upload is complete may be sent, and synchronization information may be sent (block 1116). For example, global server 230 may receive, from user device 210, a notification that a remote backup operation is to be performed. The notification may include a list of files associated with information stored by user device 210 memory. Global server 230 may compare the list of file identifiers to another list of file identifiers stored in a memory (e.g., a memory associated with global server 230). Global server 230 send an upload list to user device 210 that includes particular file identifiers that do not match any of the file identifiers of the other list of file identifiers stored in the memory. User device 210 may receive the upload list and may retrieve, from memory, information corresponding to the particular file identifiers. User device 210 may send information corresponding to the particular file identifiers to global server 230 via a public network (e.g., network 260).

Global server 230 may receive the information and may send a notification, to user device 210, when the information, associated with the particular file identifiers, is received. Global server 230 may temporarily store the information in a memory associated with global server 230. Global server 230 may receive a periodic status notification from global backup server 240 and may send a download notification to global backup server 240, in response to the status notification, indicating that the information is ready to be downloaded. Global backup server 240 may, in response to the download notification, retrieve the information and/or may store the retrieved information in database 250.

In another example, rather than using an upload list, user device 210 may retrieve timestamp information associated with a particular time at which a previous backup operation was performed. User device 210 may retrieve information that was stored by user device 210 during a time period that is after the particular time period at which the previous back up operation was performed. User device 210 may send the retrieved information to global server 230 via the public network.

In another implementation, user device 210 may upload information directly to global backup server 240. For example, user device 210 may send a notification to global server 230 to perform a remote backup operation. Global server 230 may receive the notification and may check to determine whether global backup server 240 is online, is available, and/or is otherwise operational. If global server 230 determines that global backup server 240 is online, is available, and/or is otherwise operational (e.g., by checking whether status notifications are being received from global backup server 240), then global server 230 may send, to user device 210, an address associated with global backup server 240. User device 210 may receive the address and may upload information to global backup server 240, via the public network (e.g., network 260) in a manner similar to that described above (with respect to block 1110). Global backup server 240 may communicate with local server 220 to perform a synchronization operation in a manner similar to that described above with respect to block 1012 of FIG. 10).

Implementations described herein may provide an automatic user device backup. A user may specify backup preferences information for a user device and may register the user device with a global server. A local server may be registered with the global server. Automatic backup operations may be performed to backup a copy of the information stored by the user device. The automatic backup operation may enable a user to protect information stored by the user device, which may be recovered if the user device is lost, stolen or otherwise rendered inoperable. The automatic backup operation may be performed in a manner that is transparent to the user and may be performed in accordance with backup preferences specified by the user. The backup operation may permit information to be stored locally on a local server and/or remotely on a global server and/or global backup server. The automatic backup operation may be performed via a local network (e.g., a home Wi-Fi network), which may reduce bandwidth utilization on broadband networks. If a local network is not available, however, the automatic backup operation may be performed using a global network (e.g., a broadband network, the Internet, etc.).

The foregoing description provides illustration and description, but is not intended to be exhaustive or to limit the invention to the precise form disclosed. Modifications and variations are possible in light of the above teachings or may be acquired from practice of the invention.

While series of blocks have been described with regard to FIGS. 6 and 8-11, the order of the blocks may be modified in other implementations. Further, non-dependent blocks may be performed in parallel.

It will be apparent that systems and methods, as described above, may be implemented in many different forms of software, firmware, and hardware in the implementations illustrated in the figures. The actual software code or specialized control hardware used to implement these systems and methods is not limiting of the invention. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification is taken to specify the presence of stated features, integers, steps or components but does not preclude the presence or addition of one or more other features, integers, steps, components or groups thereof.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method performed by a user device connected to a global server via a public network and connected to a local server via a private network, the method comprising:
storing, in a memory, a plurality of information and user preferences, the user preferences including information regarding a type of backup operation permitted by a user of the user device;
determining, by the user device, that the user preferences permit a local backup operation to the local server;
determining, by the user device, whether a connection, to the local server, can be established, via the private network, based on the determination that the user preferences permit the local backup operation;
sending, at least some of the information, stored in the memory, to the local server and via the connection through the private network, when the connection to the local server can be established; and
sending, the at least some of the information, stored in the memory, to the local server via the global server and the public network, when the connection to the local server cannot be established.

2. The method of claim 1, where determining whether the connection, to the local server, can be established, via the private network, includes:
sending, to the global server and via the public network, a request to perform the local backup operation to the local server; and
receiving, from the global server and via the public network, a notification that the local server is online, the notification including data that permits the user device to send the at least some of the information, stored on the user device, to the local server via the private network.

3. The method of claim 1, further comprising:
determining that the user preferences permit a remote backup operation; and
sending, the at least some of the information, stored in the memory, to the global server and via the public network, based on the determination that the user preferences permit the remote backup operation.

4. The method of claim 1, further comprising:
determining that the user preferences permit a remote backup operation;
sending, to the global server and via the public network, a request to perform the remote backup operation to the global server;
receiving, from the global server, a notification that a backup server is online, the notification including data that permits the user device to send the at least some of the information, stored on the user device, to the backup server; and
sending, to the backup server and via the public network, the at least some of the information based on the notification that the backup server is online.

5. The method of claim 1, further comprising:
determining that the user preferences permit the local backup operation to be performed via the private network or via the public network; and
performing the local backup operation, via the private network, when the connection, to the local server, can be established, based on the determination that the user preferences permit the local backup operation to be performed via the private network or via the public network.

6. The method of claim 1, where determining whether the connection, to the local server, can be established, includes:
sending, to the private network, a hello notification to determine whether the private network is available; and
receiving, from the private network and in response to the hello notification, a return hello notification indicating that the private network is available.

7. The method of claim 1, where determining whether the connection, to the local server, can be established, via the private network, includes:
sending, to the global server and via the public network, a request to perform the local backup operation to the local server;
receiving, from the global server, a notification that the local server is offline; and
determining whether the user preferences permit a temporary global backup operation to the global server; and
sending, the at least some of the information, stored in the memory, to the global server and via the public network, when the user preferences permit the temporary global backup operation to the global server.

8. The method of claim 1, where the memory stores information associated with a user preferences user interface, the method further comprising:
receiving a request to specify the user preferences;
retrieving, from the memory, the information associated with the user preferences user interface;
presenting, to a display device, the information associated with the user preferences user interface;
receiving the user preferences via the user preferences user interface; and
sending the user preferences to the global server.

9. The method of claim 1, where sending, the at least some of the information, stored in the memory, to the local server and via the connection through the private network, includes:
sending, to the local server and via the connection, an upload list, the upload list containing a plurality of file identifiers;
receiving, from the local server and via the connection, a particular file identifier of the plurality of file identifiers; and
retrieving, from the memory, the at least some of the information corresponding to the particular file identifier.

10. The method of claim 1, where sending, the at least some of the information, stored in the memory, to the local server and via the connection through the private network, includes:
reading, from the memory, timestamp information that includes a particular time when a previous backup operation was performed; and
retrieving, from the memory, the at least some information that was stored, in the memory, after the particular time.

11. A server device comprising:
a memory to store user preferences, the user preferences including information regarding a type of backup operation permitted by a user of a user device; and
a processor to:
receive a request to perform a backup operation of information stored on the user device,
determine, in response to the request, whether the user preferences permit a local backup operation to a local server or a remote backup operation to the server device,
identify a status of the local server based on a determination that the user preferences permit the local backup operation,
determine whether the user preferences permit a temporary remote backup operation, to the server device, when the status of the local server indicates that the local server is unavailable,
perform an upload operation to obtain a particular file from the user device,
temporarily store the particular file in the memory, and
provide the particular file to the local server when the local server later becomes available.

12. The server device of claim 11, where, when performing the upload operation, the processor is to:
receive, from the user device, a plurality of file identifiers,
determine whether any file identifiers, of the plurality of file identifiers, match one or more file identifiers stored in the memory, and
send, to the user device, a request to upload the particular file, corresponding to a particular file identifier, of the plurality of file identifiers, when the particular file identifier, of the plurality of file identifiers, does not match the one or more file identifiers stored in the memory.

13. The server device of claim 11, where the processor is further to:
send, to the user device, a message to perform the remote backup operation based on a determination that the user preferences permit the remote backup operation,
perform another upload operation to obtain one or more files from the user device,
store at least one file, of the one or more files in the memory,
send a notification, to the user device, indicating that the upload operation is complete, the notification including synchronization information that indicates that the at least one file, of the one or more files, was stored in the memory.

14. The server device of claim 11, where the processor is further to:
identify a status of a backup server when the user preferences permit the remote backup operation, and
send, to the user device, a message indicating that the backup server is available when the status of the backup server indicates that the backup server is available, the message including information that the user device can use to communicate with the backup server.

15. The server device of claim 11, where the processor is further to:
identify a status of a backup server when the user preferences permit the remote backup operation, and
perform the upload operation to obtain the particular file from the user device when the status of the backup server indicates that the backup server is unavailable.

16. The server device of claim 11, where the processor is further to:
determine that the local server is online when the notification is received, and
send, to the user device, a message indicating that the local server is online, the message including data that permits the user device to send information, stored on the user device, to the local server.

17. A system comprising:
a user device, connected to a global server via a public network and to a local server via a private network, to:
store, in a memory, user preferences and a plurality of files, the user preferences including information regarding which, of a plurality of types of backup operations, are specified by a user of the user device, where the plurality of types of backup operations include a remote backup operation and a local backup operation,
when the user specified the remote backup operation:
determine whether a backup server is available, via the public network,
send one or more files, of the plurality of files stored in the memory, to the backup server and via the public network, when the backup server is available, and
when the user specified the local backup operation:
determine whether a local server is available, via the private network,
send the one or more files, of the plurality of files stored in the memory, to the local server and via the private network, when the local server is available.

18. The system of claim 17, where, when the user specified the local backup operation, the user device is further to:
send the one or more files, of the plurality of files stored in the memory, to the global server and via the public network, when the local server is unavailable.

19. The system of claim 17, where, when determining whether the local server is available, via the private network, the user device is further to:
identify a status of the private network,
send a request, to perform the local backup operation, to the global server and via the public network when the status indicates that the private network is available, and
receive, from the global server and in response to the request, a notification indicating whether the local server is available.

20. The system of claim 17, where, when the user specified the remote backup operation, the user device is further to:
send the one or more files, of the plurality of files stored in the memory, to the global server and via the public network, when the backup server is unavailable.

21. The system of claim 17, where the user preferences information includes a user-specified time interval by which to perform a backup operation of the plurality of types of backup operations; and
where, when the user specified the remote backup operation or when the user specified the local backup operation, the user device is further to:
read, from the user preferences, the user-specified time interval,
compute a time period from a particular time, when a previous backup operation, of the plurality of types of backup operations, was performed, to a present time, and
determine that the backup operation, of the plurality of types of backup operations, is to be performed when the computed time period is equal to or greater than the user-specified time interval.

22. The system of claim 17, where the user preferences information indicates that a backup operation, of the plurality of types of backup operations, is to be performed when a particular file is stored in the memory; and
where, when the user specified the remote backup operation or when the user specified the local backup operation, the user device is further to:
receive or generate the particular file,
store, in an upload list, a particular file identifier, corresponding to the particular file, when the particular file is stored in the memory, and
determine, from the upload list, that the backup operation, of the plurality of types of backup operations, is to be performed when the upload list contains the particular file identifier.

23. The system of claim 17, where, when sending the one or more files, of the plurality of files stored in the memory, to the backup server and via the public network, when the backup server is available, the user device is further to:
send, to the backup server and via the public network, an upload list, the upload list containing a plurality of file identifiers corresponding to the plurality of files stored in the memory;
receive, from the backup server and via the public network, one or more file identifiers of the plurality of file identifiers,
retrieve, from the memory, the one or more files corresponding to the one or more file identifiers, and
send the one or more files to the backup server.

24. The system of claim 17, where, when sending the one or more files, of the plurality of files stored in the memory, to the local server and via the private network, when the local server is available, the user device is further to:
read, from the memory, timestamp information that includes a particular time when a previous backup operation, of the plurality of types of backup operations, was performed,
retrieve, from the memory, the one or more files, of the plurality of files, stored in the memory after the particular time, and
send the one or more files to the local server.

25. The system of claim 17, where, when the user specified the local backup operation, the user device is further to:
receive or transmit synchronization information that identifies at least one file that is not stored by both the local server and the user device,
when the at least one file is stored by the local server and not the user device, send a confirmation or a deletion request to the local server regarding the at least one file, and
when the at least one file is stored by the user device and not the local server, identify the at least one file for backup to the local server.
